(19) United States
(12) Patent Application Publication
(10) Pub. No.: US 2014/0234737 A1
(43) Pub. Date: Aug. 21, 2014

(54) ENERGY SOURCE FOR OPERATING WATERCRAFT

(71) Applicant: Friedrich-Alexander-Universitaet Erlangen-Nuernberg, Erlangen (DE)

(72) Inventor: Wolfgang Arlt, Erlangen (DE)

(21) Appl. No.: 14/347,564

(22) PCT Filed: Oct. 9, 2012
(86) PCT No.: PCT/EP2012/069924

§ 371 Date: Mar. 26, 2014

(30) Foreign Application Priority Data
Oct. 9, 2011 (DE) 10 2011 115 950.2

(51) Int. Cl. H01M 8/06; C01B 3/00

(52) U.S. Cl. CPC H01M 8/0656; C01B 3/0015
USPC 429/423; 423/658.2; 422/186.23

(57) ABSTRACT

An arrangement for charging a substrate reservoir for boats or underwater boats when traveling at the surface, comprising an energy source which is either a propulsion system driven with fossil fuels or a nuclear-powered propulsion system, and a DC current generator operated therewith; a reservoir tank for distilled or deionized water; an electrolyzer for conversion of the water from the reservoir tank with the DC current from the energy source to hydrogen and oxygen; a chemical reactor for production of a high-energy form of the substrate having an extensive π-conjugated system by chemical reaction by means of hydrogen; and a storage means for the high-energy form of the substrate produced in the reactor.

This invention relates to an energy source for operating water vehicles based on liquid organic hydrogen carriers (LOHCs), in particular in underwater or surface boats.

The publication DE 10 2011 111 565.3 describes a technology for energy supply using fuel cells.

The publication EP 1 475 349 A1 discloses various aromatic compounds, in particular condensed polycyclic hydrocarbons, usable as hydrogen storage means. The substances described are used in mobile land vehicles or in stationary land-based applications.

Fuel cells can be used to generate electrical power by oxidation of oxygen. An essential and critical aspect in the use of fuel cells is the storage of hydrogen, which is extremely explosive in the presence of oxygen.

A number of hydrogen storage methods have been examined to date: adsorptive, absorptive, as liquid, as highly compressed gas. The disadvantage of all the methods is the low energy density thereof per unit volume and the sometimes high costs of the carrier. The methods of storing hydrogen as a liquid at very low temperatures and under high pressure, which have been the standard methods to date, constitute technical solutions which can only be installed into water vehicles or underwater vehicles with considerable difficulty.

For instance, vessels containing compressed hydrogen are difficult to seal, and hydrogen explodes or detonates with pressure waves of more than 1000 m/s in almost any mixture from 4 to 75% with air. In addition, the minimum ignition energy is lower than for other gaseous substances. Hydrogen is classified as inflammable (F+) and can self-ignite at high exit velocities, as in the case of other gases too.

The formula conversion in the explosion with air is 286 kJ/mol. In the case of a warship as the underwater vehicle, the smallest hit would cause the tank contents to explode. Liquid hydrogen requires temperatures up to the triple point of hydrogen. In spite of the best insulation, these low temperatures cause heat to be supplied and hence the formation of gaseous hydrogen, which has to be discharged or combusted if the hydrogen is not being used.

If the energy reservoir of a diesel-operated submarine is hit, diesel, because of its density and low water solubility, floats immediately to the surface. If the energy reservoir of a liquid hydrogen-operated submarine is hit, the hydrogen, because of its extremely low density and solubility, likewise rises immediately to the surface.

The same applies to a submarine with a pressurized hydrogen energy storage means. If the energy reservoir of a submarine operated with hydrogen from metal hydrides is hit, there will be a vigorous chemical reaction with formation of hydrogen. All scenarios immediately betray the position of the submarine that has been hit. If a submarine with, for example, 12H-NEC as energy storage means is hit, the substance, because of the water-like density, floats up only very slowly and gives the submarine time to escape.

Nowadays, in the submarines used by the Marines, the hydrogen is stored by means of metal hydrides. Examples of these are aluminum, magnesium, palladium, LaNi₅ and TiNi—Ti₂Ni. Metals, even when they take the form of foams, considerably increase the weight of the storage means. The so-called low-temperature metal hydrides have only relatively low plateau widths (loading at constant pressure) and low storage densities of about 1.5 MJ/kg (1.2% by mass).

High-temperature metal hydrides can achieve higher storage densities of about 3.3 to 3.4% by mass based on the system weight (4 MJ/kg), but these are difficult to insulate from the environment in a generally confined underwater vehicle.

In the course of charging or discharging, a metal is in equilibrium with the hydrogen gas, such that hydrogen in the metal at interstitial sites is initially dissolved (solid-state solution). In this solution phase (alpha phase), the hydrogen pressure rises at low concentration.

If the concentration reaches a particular value of about 0.1 hydrogen atom per metal atom, a hydride phase (beta phase) begins to form from the solution phase. In the region of coexistence of the solution phase and the hydride phase, the concentration grows at constant external pressure (plateau). Once the hydride phase has fully formed, further hydrogen can be dissolved in the hydride phase. The equilibrium pressure now rises again with the concentration. The plateau pressure and the plateau length in the pressure/concentration isotherms are temperature-dependent and thus allow charging and discharging.

The hydrogen absorption and desorption do not proceed at any desired rate. The reaction includes several successive steps: diffusion in the gas, chemisorption and dissociation of the molecule, diffusion in the metal lattice, nucleation and growth of the hydride phase.

The slowest step determines the kinetics of the hydrogen absorption and desorption. Although the hydrogen atom is small and becomes even smaller as a result of the chemical bonding to the metal, the incorporation of the hydrogen atom strains and distorts the metal lattice. The crystal lattice of the metal hydride is expanded by 10 to 20% by volume compared to the lattice of the pure metal. The expansion is often anisotropic, meaning that the metal expands to different extents in the different crystal directions. This leads to fracture of the particles. Existing metal hydride storage means therefore frequently have fine filters for retention of fine particles which would be discharged in the course of discharge of the storage means. This makes metal hydride storage means costly and means that they cannot be charged as often as desired.

It is therefore an object of the present invention to avoid the disadvantages of the metal hydride storage means utilized nowadays in water vehicles. It is a further object of the present invention to specify an arrangement for operation of water vehicles which works substantially at ambient pressure; can be fuelled externally, for example in a harbor; does not have high evolution of heat like metal hydrides, such that the charging/discharging efficiency is high; in warships, tolerates hits to the tank and does not betray the position thereof; has a high storage density at low pressure; can be charged and discharged very frequently without formation of ultrafine dust, and in which hydrogen is present in a non-explosive form in the storage means.

This object is achieved by subject matter having the features according to the independent claims.

Advantageous embodiments are the subject of the description, the figures and the dependent claims.

The present invention is based on the finding that it is desirable to provide a technology for energy supply using fuel cells, which avoids the risks associated with pure hydrogen at low temperatures or under pressure, and the use of metal hydrides.

The term “underwater boat” is understood to mean a manned or unmanned boat which is regularly operated traveling partly or fully submersed underwater.

In a first aspect, the object is achieved by an arrangement for charging a reservoir of high-energy substrate for boats or underwater boats when traveling at the surface, comprising an energy source which is either a propulsion system driven with fossil fuels or a nuclear-powered propulsion system, and a DC current generator operated therewith; a reservoir tank for distilled or deionized water; an electrolyzer for conversion of the water from the reservoir tank with the DC current from the energy source to hydrogen and oxygen; a reservoir tank for oxygen; a chemical reactor for production of a high-energy form of the substrate having an extensive π-conjugated system by chemical reaction by means of hydrogen; and a storage means for the high-energy form of the substrate produced in the reactor.

Liquid hydrogen carriers are loaded with hydrogen on land or during travel, which is then released again during a surface journey or underwater journey and hence allows propulsion by means of a fuel cell or of an explosion motor. Fueling on land or from a tanker boat is also conceivable.

The basis of the mode of action of condensed polycyclic hydrocarbons having an extensive π-conjugated electron system is the propensity thereof to be subject to a hydrogenation reaction at moderate temperatures in the presence of a suitable catalyst. This incorporates hydrogen into the substance with saturation of the unsaturated double bonds (hydrogenation).

The hydrogen incorporated by means of hydrogenation can subsequently be recovered again from the hydrogenated product in the reverse reaction merely by increasing the temperature and/or reducing the hydrogen pressure, with regeneration of the aromatic substance.

In an advantageous embodiment, the arrangement is designed to feed the energy source and deionized or distilled water from the tank to an electrolyzer, the produced hydrogen of which is utilized for complete or partial hydrogenation of the low-energy form of the substrate having the extensive π-conjugated system (LOHC) in a chemical reactor.

In a second aspect, the object is achieved by an arrangement for electrical propulsion of boats or underwater boats when traveling underwater, comprising an energy source in the form of the high-energy form of a substrate having an extensive π-conjugated system; a reservoir tank for oxygen or air; a chemical reactor for production of hydrogen from the substrate having the extensive π-conjugated system; a fuel cell for production of DC current and water; and an electrical propulsion system for conversion of the DC current to forward motion.

In an advantageous embodiment, the arrangement is designed to utilize the reservoir tank having high-energy form with at least one chemical reactor and at least one fuel cell to operate the electrical propulsion system.

In a further advantageous embodiment, the substrate having the extensive π-conjugated system is selected from a group comprising polycyclic aromatic hydrocarbons, polycyclic heteroaromatic hydrocarbons, π-conjugated organic polymers or a combination thereof.

In a further advantageous embodiment, the substrate having the extensive π-conjugated system is selected from a group comprising condensed heteroaromatic hydrocarbons having N, S or O as heteroatom, wherein the heteroatoms are substituted or unsubstituted.

In a further advantageous embodiment, the condensed heteroaromatic hydrocarbons are ring systems having C6 to C30, preferably C8 to C20, in particular C12.

In a further advantageous embodiment, the heteroatoms are substituted by at least one alkyl group, at least one aryl group, at least one alkenyl group, at least one alkynyl group, at least one cycloalkyl group and/or at least one cycloalkylene group.

In a further advantageous embodiment, the heteroatoms are substituted by C1-C30-alkyl, preferably C1-C10-alkyl, in particular by C2-C5-alkyl.

In a further advantageous embodiment, the arrangement comprises an additive which raises the density of the substrate above 1 g/ml.

In a further advantageous embodiment, the substrate having the extensive π-conjugated system is N-ethyl-carbazole, N-n-propylcarbazole, N-isopropylcarbazole.

In a further advantageous embodiment, the arrangement is designed to at least partly hydrogenate the substrate having the extensive π-conjugated system in the chemical reactor (h) at a temperature between 50 and 180° C. and a pressure between 2 and 200 bar in the presence of a suitable catalyst.

In a further advantageous embodiment, the arrangement is designed to at least partly dehydrogenate the hydrogenated substrate in the chemical reactor (c) at a temperature between 120 and 250° C. and at standard pressure in the presence of a suitable catalyst.

In a third aspect, the object is achieved by a method of generating energy in boats or underwater boats traveling at the surface, in particular in submarines, comprising the steps of generating DC current with an energy source which is either a propulsion system driven with fossil fuels or a nuclear-powered propulsion system, and a DC current generator operated therewith; storing distilled or deionized water in a reservoir tank; converting the water from the reservoir tank with the DC current from the energy source to hydrogen and oxygen in an electrolyzer; storing oxygen in a reservoir tank; producing a high-energy form of the substrate having an extensive π-conjugated system by chemical reaction by means of hydrogen in a chemical reactor; and storing the high-energy form of the substrate produced in the reactor in a storage means.

In a fourth aspect, the object is achieved by a method of supplying energy in boats or submersed underwater boats, in particular in submarines, with an energy source in the form of the high-energy form of a substrate having an extensive π-conjugated system, comprising the steps of storing oxygen or air in a reservoir tank; producing hydrogen from the substrate having the extensive π-conjugated system in a chemical reactor; producing DC current and water in a fuel cell; and converting the DC current to forward motion in an electrical propulsion system.

In an advantageous embodiment, the method envisages the fueling of the boat or underwater vehicle from land or from a tanker boat with high-energy form of the substrate having the extensive π-conjugated system.

The invention is elucidated in detail hereinafter with reference to the figures by several working examples. The figures show:

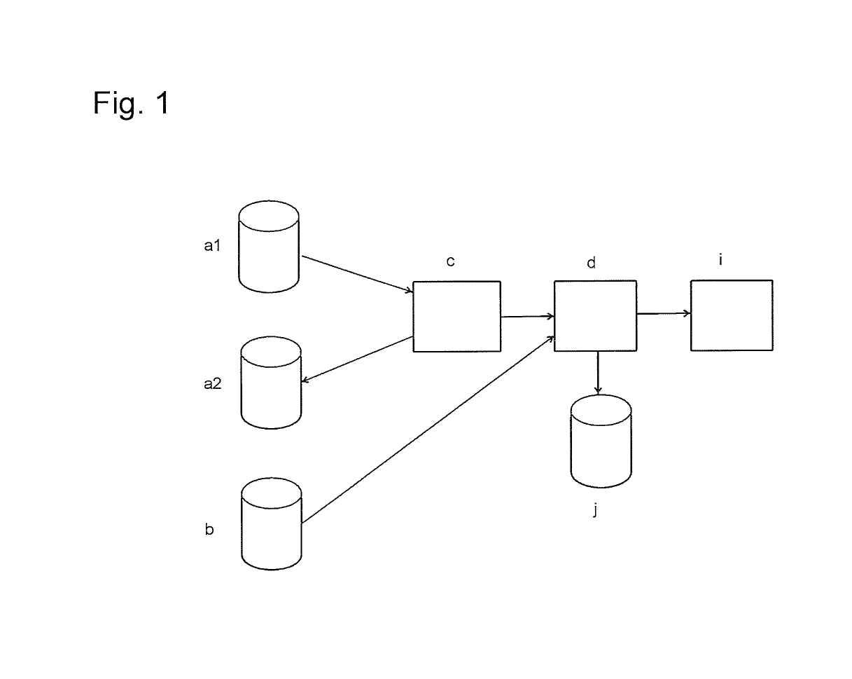

FIG. 1: a schematic diagram of one embodiment of an arrangement when traveling underwater; and

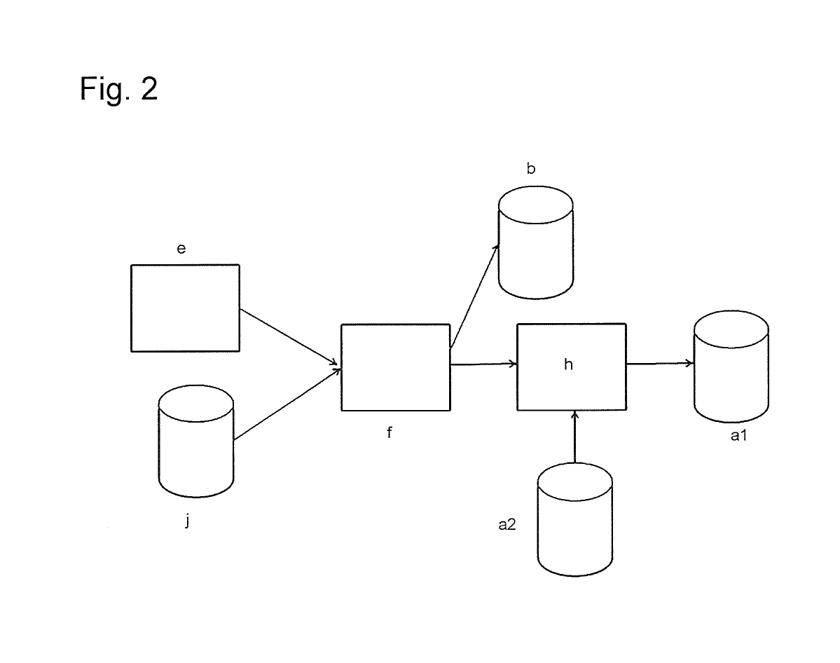

FIG. 2: a schematic diagram of one embodiment of an arrangement when traveling on the surface.

FIG. 1 shows a preferred embodiment of the arrangement in schematic form for travel underwater. The energy source a1 chosen is the high-energy form of a liquid organic hydrogen carrier LOHC. In a chemical reactor c, hydrogen is eliminated chemically and exothermically from the high-energy form. The hydrogen produced in c is converted exothermically to DC current with oxygen from the reservoir vessel b in the fuel cell d.

Reference is made here by way of example to the hydrogenation/dehydrogenation of N-ethylcarbazole (NEC) as substrate of a liquid organic hydrogen carrier. This involves conversion of N-ethylcarbazole (NEC) as the reactant to the perhydro form (H12-NEC) according to the following reaction scheme:

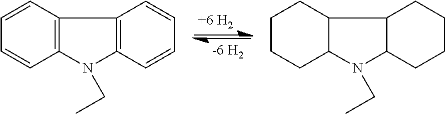

The high-energy form (for example H12-NEC) and the low-energy form (for example NEC) are collectively referred to as LOHC (liquid organic hydrogen carrier). The storage density for hydrogen is of this reaction about twice as high in terms of volume as in a hydrogen-filled 700 bar tank. Taking a submarine as an example of an underwater boat, for the U212A series, the power supply has to be ensured by 9 PEM fuel cells which add up to 306 kW. The density of H12-NEC can be increased by additives in order to completely prevent floating. The use of heat for heating of the underwater boat is not shown. The water inevitably formed is stored in the reservoir tank j. The DC current produced in the fuel cell d is used for the electrical boat propulsion system i.

FIG. 2 shows a preferred embodiment of the arrangement in schematic form for surface travel. Here, the reservoir of high-energy form is to be supplemented by another energy source. The energy source e used is a propulsion system with fossil fuels or by nuclear reaction, which operate an electrical generator which preferably produces DC current. Distilled or deionized water is withdrawn from a reservoir tank j. The DC current from the energy source e and the water from the reservoir tank j are converted in an electrolyzer f to hydrogen and oxygen. The oxygen is passed into the reservoir tank b, while the hydrogen produced is utilized immediately, without intermediate storage, for complete or partial hydrogenation of the low-energy form of the LOHC.

The arrangement for underwater travel of an underwater vehicle consists of:

(a) at least two tanks for a liquid organic hydrogen carrier LOHC, namely one for the hydrogenated (high-energy) form a1 and another for the dehydrogenated (low-energy) form a2. In a particular embodiment, a moving wall for the separation of the two forms of the liquid organic hydrogen carrier LOHC means that only one tank is needed. The amount of liquid hydrogen carrier LOHC remains virtually the same during the charging or discharging operation—only the hydrogen from the high-energy form is required. In a particular embodiment, the density of the high-energy and low-energy forms is raised above the value of 1 g/ml by a miscible substance. This substance itself must have a density greater than 1 g/ml.

(b) at least one reservoir vessel of oxygen for operation of the fuel cell. In a particular embodiment of an air-operated fuel cell, an air reservoir is also possible.

(c) at least one chemical reactor which, by means of a catalyst and elevated temperature, releases at least some of the hydrogen for the fuel cell from the high-energy form and returns the discharged or partly discharged substrate to the tank.

(d) at least one fuel cell which is operated with the oxygen from b and the hydrogen from the chemical reactor c and releases the water formed for further use in the underwater boat or, in a particular embodiment, to the reservoir tank j.

(i) an electrical boat propulsion system.

In one arrangement, during surface travel of the underwater vehicle, the reservoir tank of liquid organic hydrogen carrier LOHC can also be charged by the use of fossil fuels. This arrangement consists of

(e) at least one propulsion system operated with fossil fuels or nuclear power, which drives a generator which produces electrical power.

(j) a reservoir vessel of distilled or deionized water

(f) at least one electrolysis cell which breaks down the power generated in e by electrolysis to oxygen and hydrogen.

(g) a recycle line for the oxygen produced in the reservoir vessel f to the reservoir vessel b.

(h) at least one chemical reactor which conducts the hydrogenation of at least one substrate having an extensive π-conjugated system from the tank a2 using the hydrogen formed in the electrolyzer f′ and stores the high-energy form in the tank a1.

The laden form of the liquid organic hydrogen carrier LOHC, for example H12NEC, can be dispensed, for example, in a harbor or by tanker boat as a diesel-like liquid, by exchanging NEC for H12NEC.

Thus, the following functional elements are coupled or combined for the operation of underwater boats: storage of the hydrogen at ambient pressure in a comparatively nonflammable liquid, namely the high-energy form of the liquid organic hydrogen carrier; high rates of charging and discharging of the liquid organic hydrogen carrier LOHC; a high efficiency of charging and discharging; a fuel cell for conversion of the hydrogen to power; a high energy density in the storage means and an external supply of liquid organic hydrogen carrier LOHC in the harbor or by tanker boats.

The present arrangement thus enables long-lasting underwater travel on the basis of the current standard infrastructure, for example with use of a diesel tank. The advantage of the present arrangement and of the process described subsequently is that the useful space in a boat or underwater boat is optimally utilized by an ambient pressure tank with high energy density.

This tank can assume any desired shape. A further advantage is that the hydrogen, which is an essential factor for power generation, in contrast to many processes and models known to date, need not be present in large volumes, but can be stored in a chemical substance safely and at ambient pressure in an existing infrastructure for an unlimited time.

A further advantage is the possibility of pumping out the low-energy form of the liquid hydrogen carrier and replacing it with the high-energy form in a harbor or on a tanker boat. This achieves rapid availability, as in the current dispensing operations with diesel.

In a preferred embodiment, the reservoir tanks for the liquid organic hydrogen carrier LOHC and the oxygen are connected to the at least one fuel cell via the chemical reactor. Thus, the individual components or constituents of the present arrangement constitute an integrated system for energy provision. The individual cells and reactors of the present arrangement are connected by suitable connecting lines for transfer of hydrogen and of the low-energy or high-energy form of the liquid organic hydrogen carrier LOHC.

The lines for hydrogen transport are preferably produced from gas-tight and pressure-resistant materials. In a preferred embodiment, a generator for electricity is connected to another energy source via an electrolysis cell, and a further chemical reactor to the tanks for the low-energy and high-energy form. Thus, the individual components or constituents of the present arrangement constitute an integrated system for energy storage and enable replenishment when traveling at the surface.

It is preferable that the at least one low-energy substrate of the liquid organic hydrogen carrier LOHC having an extensive π-conjugated system is selected from a group comprising polycyclic aromatic hydrocarbons, polycyclic heteroaromatic hydrocarbons, π-conjugated organic polymers or a combination thereof.

In one embodiment, the at least one low-energy substrate having an extensive π-conjugated system is selected from a group comprising condensed heteroaromatic hydrocarbons having N, S or O as heteroatom, where the heteroatoms are substituted or unsubstituted. These condensed heteroaromatic hydrocarbons are preferably ring systems having C₆ to C₃₀, preferably C₈ to C₂₀, in particular C₁₂.

In a further preferred embodiment, the heteroatoms of the condensed hydrocarbons are substituted by at least one alkyl group, at least one aryl group, at least one alkenyl group, at least one alkynyl group, at least one cycloalkyl group and/or at least one cycloalkenyl group, where substitutions of the heteroatoms by C₁-C₃₀-alkyl, preferably C₁-C₁₀-alkyl, in particular by C₂-C₅-alkyl are advantageous and further heteroatoms may be present.

In a particularly preferred embodiment, the low-energy substrate used which is suitable for storage of hydrogen is N-ethylcarbazole, N-n-propylcarbazole or N-isopropylcarbazole.

The term “substituted” in use with alkyl, alkenyl, aryl, etc., relates to the replacement of one or more atoms, generally hydrogen atoms, by one or more of the following substituents, preferably by one or two of the following substituents: halogen, hydroxyl, protected hydroxyl, oxo, protected oxo, C₃-C₇-cycloalkyl, bicyclic alkyl, phenyl, naphthyl, amino, protected amino, monosubstituted amino, protected monosubstituted amino, disubstituted amino, guanidino, protected guanidino, a heterocyclic ring, a substituted heterocyclic ring, imidazolyl, indolyl, pyrrolidinyl, C₁-C₁₂-alkoxy, C₁-C₁₂ acyl, C₁-C₁₂-acyloxy, acryloyloxy, nitro, carboxyl, protected carboxyl, carbamoyl, cyano, methylsulfonylamino, thiol, C₁-C₁₀-alkylthio and C₁-C₁₀-alkylsulfonyl.

The substituted alkyl groups, aryl groups or alkenyl groups may be mono- or polysubstituted and preferably mono- or disubstituted by identical or different substituents.

The term “alkynyl”, as used here, refers to a radical of the formula R—C≡C—, in particular a C₂-C₆-alkynyl. Examples of C₂-C₆-alkynyls include: ethynyl, propynyl, 2-butynyl, 2-pentynyl, 3-pentynyl, 2-hexynyl, 3-hexynyl, 4-hexynyl, vinyl, and di- and triynes of straight and branched alkyl chains.

The term “aryl”, as used herein, refers to aromatic hydrocarbons, for example phenyl, benzyl, naphthyl or anthryl. Substituted aryl groups are aryl groups substituted as defined above by one or more substituents as defined above.

The term “cycloalkyl” comprises the cyclopropyl, cyclobutyl, cyclopentyl, cyclohexyl and cycloheptyl groups.

The term “cycloalkenyl” comprises the cyclopentenyl, cyclohexenyl, cycloheptenyl and cyclooctenyl groups.

It is advantageous when the low-energy substrate having an extensive π-conjugated system is at least partly hydrogenated in the chemical reactor h at a temperature between 50 and 180° C., preferably 80 and 150° C., and a pressure between 2 and 200 bar, preferably 10 to 100 bar, in the presence of a suitable noble metal catalyst.

Particularly suitable catalysts for the hydrogenation of the low-energy substrate contain the element ruthenium.

It is advantageous when the high-energy substrate is at least partly dehydrogenated in the chemical reactor c at a temperature between 120 and 250° C. and at standard pressure in the presence of a suitable catalyst. Particularly suitable catalysts for the hydrogenation contain the element platinum.

In a further embodiment, the fuel cell used is a low-temperature polymer electrolyte membrane fuel cell (PEM). These fuel cells can be used not just in their actual function for hydrogen oxidation but can likewise be operated in reverse function as an electrolyzer, in which case the water required for the electrolysis is drawn from the reservoir j.

It is likewise advantageous when at least one water-storing medium j is arranged in the at least one electrolyzer f. The storage tank preferably used for the intermediate storage of the high-energy and any low-energy form of the hydrocarbon used has the configuration and structure of conventional diesel tanks typically used.

The present arrangement enables the provision of electrical energy in submersed underwater boats, comprising the following steps utilizing a reservoir of high-energy substrate for production of hydrogen and operating a fuel cell for provision of electrical energy for the electrical boat propulsion system.

The present arrangement enables the charging of the reservoir of high-energy substrate in surfaced underwater boats using the above arrangement, comprising the following steps providing electrical power, preferably a DC current, from at least one fossil propulsion system or by nuclear power, producing hydrogen from water in at least one electrolyzer using the electrical power, transferring the hydrogen formed from the at least one electrolyzer to a chemical reactor h containing at least one substrate having an extensive π-conjugated system and at least partly hydrogenating the substrate, transferring the at least partly hydrogenated substrate from the chemical reactor h into at least one storage tank.

Thus, there is complete recycling of the liquid organic hydrogen carrier LOHC used. Since the substrate used is not consumed, very long use periods or a large number of recycling cycles (underwater travel/surface travel) are attainable.

In one embodiment of the present method, the hydrogen produced in the electrolyzer f is used without intermediate storage for at least partial hydrogenation of the at least one substrate having an extensive π-conjugated system in the chemical reactor h. The hydrocarbon to be at least partly hydrogenated is preferably in liquid form in the chemical reactor h.

However, it would also be conceivable to use hydrocarbons in the solid state. In addition, it is advantageous when the heat which arises in the at least partial hydrogenation of the at least one substrate having an extensive π-conjugated system in the chemical reactor h is introduced into a heating system of the underwater boat.

It is also advantageous when the water formed in the fuel cell during the hydrogen oxidation is transferred into the electrolyzer. It is likewise conceivable that the water formed in the fuel cell is only partly recycled. The heat released in the fuel cell c is preferably introduced into the heating system of the underwater boat. The oxygen required for the hydrogen oxidation in the fuel cell is operated from a tank b, which introduces the oxygen formed in the electrolyzer f during the water hydrolysis directly into the fuel cell. Thus, the underwater boat is very substantially free of an external oxygen supply.

This hydrogenation is conducted in the chemical reactor h using the low-energy form from tank a2. Full hydrogenation is possible but unnecessary. The high-energy substrate is stored in the reservoir tank a1 and is available for underwater travel. In one variant of this preferred embodiment, the reservoir tank a1 is filled on land or by means of a tanker boat, and the aliquot amount from the tank a2 is taken onto land or into the tanker boat in order to obtain the mass ratios.

The basis of a working example is formed by the design of the U212A submarine series, which is equipped in electrical terms with a PEM fuel cell arrangement having a total power of 306 kW. The efficiency is said to be 65%; the energy supplied to the fuel cell is thus 471 kW in thermal form. The supply is to be operated with the liquid organic hydrogen carrier H12-NEC/NEC. The density of the two substances is assumed to be 1 g/ml for simplicity of calculation, which corresponds to the true conditions with sufficient accuracy.

In theoretical terms, 58 g of hydrogen are stored in one kg/liter of H12-NEC, but only 52 g are utilizable; thus, 1.9 kWh of thermal energy are stored in one liter of H12-NEC; in order to attain the power of 471 kW, 471/1.9=248 kg/liter of H12-NEC per hour would thus have to be converted. If the underwater boat is to run at maximum power underwater for 24 h, a reservoir store of high-energy form of 5952 liters=5952 kg is needed.

The basis of a counter-example is the same as in the working example, except that a metal hydride storage means TiNi—Ti2Ni having a storage density of 1 kWh/liter of volume is to be utilized, corresponding to about 2 kg. In order to reproduce the thermal power of 471 kW, a volume of 471 liters must be available. For a 24 h run, the volume of 11 304 liters or 22 608 kg thus has to be available. In terms of weight, almost four times more weight thus has to be available. Even optimization of the metal hydride storage means by a factor of two makes the system less efficient than the present invention.

The present invention further relates to:

A first arrangement for electrical propulsion of underwater boats when traveling underwater, comprising at least one energy source “a1” in the form of the high-energy form of an LOHC; at least one reservoir tank for oxygen or air “b”; at least one chemical reactor “c” for production of hydrogen from a substrate having an extensive π-conjugated system; at least one fuel cell “d” which produces DC current and water; at least one electrical propulsion system “i” which converts the DC current to forward motion.

A second arrangement for charging the reservoir of high-energy substrate for underwater boats when traveling at the surface, comprising at least one energy source “e” which is either a propulsion system driven with fossil fuels or a nuclear-powered propulsion system, and a DC current generator operated therewith; at least one reservoir tank “j” for distilled or deionized water; at least one electrolyzer which converts the water from “j” with the DC current from “e” to hydrogen and oxygen; at least one reservoir tank for oxygen “b”; at least one chemical reactor “h” for production of a high-energy form of a substrate having an extensive π-conjugated system by chemical reaction by means of hydrogen; at least 1 storage means “a1” for the high-energy form produced in the reactor “h”.

A third arrangement having the features of the first arrangement, in which the at least one reservoir tank of high-energy form “a1” is utilized with at least one chemical reactor “c” and at least one fuel cell “d”, in order to operate the electrical boat propulsion system “i”.

A fourth arrangement having the features of the second arrangement, in which the energy source “e” and deionized or distilled water from the tank “i” are fed to at least one electrolyzer “f”, and the hydrogen produced therein is utilized in a chemical reactor “h” for complete or partial hydrogenation of the low-energy form of the LOHC.

A fifth arrangement having the features of the first to fourth arrangements, in which the at least one substrate having an extensive π-conjugated system is selected from a group comprising polycyclic aromatic hydrocarbons, polycyclic heteroaromatic hydrocarbons, π-conjugated organic polymers or a combination thereof.

A sixth arrangement having the features according to any of the preceding arrangements, in which the at least one substrate having an extensive π-conjugated system is selected from a group comprising condensed heteroaromatic hydrocarbons having N, S or as O heteroatom, wherein the heteroatoms are substituted or unsubstituted.

A seventh arrangement having the features of the fifth arrangement, in which the condensed heteroaromatic hydrocarbons are ring systems having C6 to C30, preferably C8 to C20, in particular C12.

An eighth arrangement having the features of the fifth or sixth arrangement, in which the heteroatoms are substituted by at least one alkyl group, at least one aryl group, at least one alkenyl group, at least one alkynyl group, at least one cycloalkyl group and/or at least one cycloalkylene group.

A ninth arrangement having the features of any of the fifth to eighth arrangements, in which the heteroatoms are substituted by C₁-C₃₀-alkyl, preferably C₁-C₁₀-alkyl, in particular by C₂-C₅-alkyl.

A substrate or a tenth arrangement having the features of the fifth to ninth arrangements, comprising an additive which raises the density of the substrate above 1 g/ml.

An eleventh arrangement having the features of the first to tenth arrangements, in which the substrate used which has an extensive π-conjugated system is N-ethylcarbazole, N-n-propylcarbazole, N-isopropyl-carbazole.

A twelfth arrangement having the features of any of the preceding arrangements, in which the substrate having an extensive π-conjugated system is at least partly hydrogenated in the chemical reactor nil at a temperature between 50 and 180° C. and a pressure between 2 and 200 bar in the presence of a suitable catalyst.

A thirteenth arrangement having the features of any of the preceding arrangements, in which the hydrogenated substrate is at least partly dehydrogenated in the chemical reactor (“c”) at a temperature between 120 and 250° C. and at standard pressure in the presence of a suitable catalyst.

A first method of supplying energy in submersed underwater boats, in particular in submarines, having the features of the first and third arrangements.

A second method of generating energy in underwater boats traveling at the surface, in particular in submarines, having the features of the second and fourth arrangements.

A third method having the features of the second method, which envisages the fueling of the underwater vehicle from land or from a tanker boat with high-energy form of the LOHC.

All the features elucidated and shown in conjunction with individual embodiments of the invention may be provided in different combinations in the subject matter of the invention, in order to achieve their advantageous effects simultaneously.

The scope of protection of the present invention is given by the claims and is not restricted by the features elucidated in the description or shown in the figures.

1. An arrangement for charging a substrate reservoir for boats or underwater boats when traveling at the surface, comprising:
an energy source which is either a propulsion system driven with fossil fuels or a nuclear-powered propulsion system, and a DC current generator operated therewith;
a reservoir tank for distilled or deionized water;
an electrolyzer for conversion of the water from the reservoir tank with the DC current from the energy source to hydrogen and oxygen;
a chemical reactor for production of a high-energy form of the substrate having an extensive π-conjugated system by chemical reaction by means of the hydrogen; and
storage means for the high-energy form of the substrate produced in the reactor (h).

2. The arrangement as claimed in claim 1, wherein the arrangement is designed to feed the DC current and the deionized or distilled water from the reservoir tank to the electrolyzer, the produced hydrogen of which is utilized in the chemical reactor for complete or partial hydrogenation of the low-energy form of the substrate having the extensive π-conjugated system (LOHC).

3. An arrangement for electrical propulsion of boats or underwater boats when traveling underwater, comprising:
a high-energy substrate having an extensive π-conjugated system (LOHC);
a chemical reactor for production of hydrogen from the substrate having the extensive π-conjugated system;
a fuel cell for production of DC current and water from the hydrogen; and
an electrical propulsion system for conversion of the DC current to forward motion.

4. The arrangement as claimed in claim 3, wherein the arrangement is designed to utilize a reservoir tank having the high-energy substrate with the chemical reactor and the fuel cell to operate the electrical propulsion system.

5. The arrangement as claimed in claim 1, wherein the substrate having the extensive π-conjugated system is selected from the group consisting of polycyclic aromatic hydrocarbons, polycyclic heteroaromatic hydrocarbons, π-conjugated organic polymers, and combinations thereof.

6. The arrangement as claimed in claim 1, wherein the substrate having the extensive π-conjugated system is selected from the group comprising consisting of condensed heteroaromatic hydrocarbons having N, S, or O as heteroatom, wherein the heteroatoms are substituted or unsubstituted.

7. The arrangement as claimed in claim 5, wherein the substrate is selected from heteroaromatic hydrocarbons that are ring systems having C₆ to C₃₀.

8. The arrangement as claimed in claim 5, wherein the heteroatoms are substituted by at least one alkyl group, at least one aryl group, at least one alkenyl group, at least one alkynyl group, at least one cycloalkyl group, and/or at least one cycloalkylene group.

9. The arrangement as claimed in claim 5, wherein the heteroatoms are substituted by C₁-C₃₀-alkyl.

10. The arrangement as claimed in claim 1, wherein the arrangement comprises an additive which raises the density of the substrate above 1 g/ml.

11. The arrangement as claimed in claim 1, wherein the substrate having the extensive π-conjugated system is N-ethyl-carbazole, N-n-propylcarbazole, or N-isopropyl-carbazole.

12. The arrangement as claimed in claim 1, wherein the arrangement is designed to at least partly hydrogenate the substrate having the extensive π-conjugated system in the chemical reactor at a temperature between 50° C. and 180° C. and a pressure between 2 bar and 200 bar in the presence of a catalyst.

13. The arrangement as claimed in claim 1, wherein the arrangement is designed to at least partly dehydrogenate the hydrogenated substrate in the chemical reactor at a temperature between 120° C. and 250° C. and at standard pressure in the presence of a suitable catalyst.

14. A method of generating energy in boats or underwater boats traveling at the surface, comprising the steps of:
generating DC current with an energy source which is either a propulsion system driven with fossil fuels or a nuclear-powered propulsion system, and a DC current generator operated therewith;
storing distilled or deionized water in a reservoir tank;
converting the water from the reservoir tank with the DC current from the energy source to hydrogen and oxygen in an electrolyzer;
producing a high-energy form of the substrate having an extensive π-conjugated system by chemical reaction by means of hydrogen in a chemical reactor; and
storing the high-energy form of the substrate produced in the reactor in storage means.

15. A method of supplying energy in boats or submersed underwater boats by means of a high-energy substrate having an extensive π-conjugated system (LOHC), comprising the steps of:
producing hydrogen from the substrate having the extensive π-conjugated system in a chemical reactor;
producing DC current and water in a fuel cell from the hydrogen; and
converting the DC current to forward motion in an electrical propulsion system.

16. The method as claimed in claim 15, which envisages the fueling of the boat or underwater vehicle from land or from a tanker boat with high-energy form of the substrate having the extensive π-conjugated system (LOHC).

17. The arrangement as claimed in claim 7, wherein the substrate is selected from heteroaromatic hydrocarbons that are ring systems having C₈ to C₂₀.

18. The arrangement as claimed in claim 17, wherein the substrate is selected from heteroaromatic hydrocarbons that are ring systems having C₁₂.

19. The arrangement as claimed in claim 9, wherein the heteroatoms are substituted by C₁-C₁₀-alkyl.

20. The arrangement as claimed in claim 19, wherein the heteroatoms are substituted by C₂-C₅-alkyl.
